(19) United States
(12) Patent Application Publication
(10) Pub. No.: US 2010/0124223 A1
(43) Pub. Date: May 20, 2010

(54) SELECTIVE PAGING IN WIRELESS NETWORKS

(76) Inventors: Andrew GIBBS, Andover, MA (US); Rajeev KOODLI, Sunnyvale, CA (US); Kuntal CHOWDHURY, Andover, MA (US)

Correspondence Address: WILMERHALE/NEW YORK, 399 PARK AVENUE, NEW YORK, NY, 10022, US

(21) Appl. No.: 12/621,231

(22) Filed: Nov. 18, 2009

Related U.S. Application Data
(60) Provisional application No. 61/115,812, filed on Nov. 18, 2008.

(51) Int. Cl. H04L 12/56; H04L 12/28

(52) U.S. Cl. 370/389; 370/411

(57) ABSTRACT

A method and system for selectively paging user equipment in a communication network is disclosed. The selective paging is implemented with a set of rules that determine whether a packet triggers a page request to user equipment. The rules can be dynamic and can discard unwanted packets to avoid waste of system resources, disruptions in service, and draining of a user equipment's battery life. The selective paging can be implemented on a serving gateway (SGW), a packet data network gateway (PGW), a mobility management entity, or a combination of the three. The selective paging can use information regarding the state of the user equipment and other rule-based criteria to determine whether packets received by a gateway trigger a page of the user equipment.

### CROSS-REFERENCE TO RELATED APPLICATIONS

This application claims benefit under 35 U.S.C. §119(e) of U.S. Provisional Patent Application No. 61/115,812, entitled “Selective Paging in Wireless Networks,” filed Nov. 18, 2008, which is hereby incorporated by reference herein in its entirety.

### FIELD OF THE DISCLOSURE

This disclosure relates to a system and method for providing selective paging in a communication network.

### BACKGROUND

Wireless networks are telecommunications networks that use radio waves to carry information from one node in the network to one or more receiving nodes in the network. Cellular telephony is characterized by the use of radio cells that provide radio coverage for a geographic area, with multiple cells arranged to provide contiguous radio coverage over a larger area. Wired communication can also be used in portions of a wireless network, such as between cells or access points.

The first generation of wireless telephone technology used analog mobile phones in which analog information signals were modulated and transmitted. In second generation (2G) systems, digital information signals were used to modulate a carrier. These 2G technologies used time division multiplex access (TDMA) technology for GSM systems, or code division multiple access (CDMA) technologies for IS-95 systems to distinguish multiple users. Such networks were further upgraded to handle higher-speed packet data using GPRS/EDGE and then HSPA, and CDMA 1×-EVDO in networks referred to as 2.5G and 3G networks. The next evolution is 4G technology, which is referred to as long term evolution-system architecture evolution (LTE-SAE) and uses orthogonal frequency division multiple access (OFDMA) technology. Other wireless protocols have also developed including WiFi (an implementation of various IEEE 802.11 protocols), WiMAX (an implementation of IEEE 802.16), and HiperMAN, which is based on an ETSI alternative to IEEE 802.16.

Wireless communication technologies are used in connection with many applications, including, for example, satellite communications systems, portable digital assistants (PDAs), laptop computers, and mobile devices (e.g., cellular telephones, user equipment). Users of such applications can connect to a network (e.g., the Internet) as long as the user is within range of such a wireless communication technology. The range of the wireless communication technology can vary depending on the deployment. A macro cell transceiver is typically used by service providers to provide coverage over about a five kilometer distance. A pico cell transceiver can provide coverage over about a half kilometer distance, and a femto cell transceiver can provide coverage over a 50-200 meter distance. A femto cell transceiver is similar in coverage to a WiFi (WLAN) access point and can be used to provide network access over a short range.

### SUMMARY OF DISCLOSURE

A method and system for selectively paging user equipment in a communication network is disclosed. The selective paging is implemented with a set of rules that determine whether a packet triggers a page request to user equipment. The rules can be dynamic and can discard unwanted packets to avoid waste of system resources, disruptions in service, and draining of a user equipment's battery life. The selective paging can be implemented on a serving gateway (SGW), a packet data network gateway (PGW), a mobility management entity, or a combination of the three. The selective paging can use information regarding the state of the user equipment and other rule-based criteria to determine whether packets received by a gateway trigger a page of the user equipment.

In some embodiments, a gateway in a communication network that receives packets destined for user equipment is described that includes an interface configured to receive a packet destined toward a user equipment, and an interface configured to initiate a page request, wherein the gateway is configured to determine, based on information from the packet, which user equipment the packet is destined for and for qualifying the packet to initiate a page request to the user equipment, wherein the packet is qualified when the user equipment is in an idle state and wherein the packet passes a qualification procedure that includes inspecting the packet according to one or more rules to determine whether the packet is eligible for transmission to the user equipment, wherein the gateway refrains from paging the user equipment if the packet is not qualified.

In other embodiments, a method of selective paging at a gateway in a communication network is described, the method including receiving a packet at the gateway, determining to which user equipment the packet is destined, accessing state information for that user equipment, initiating, at the gateway, a qualifying procedure on the packet when the user equipment is in an idle state and the packet would trigger a page request, inspecting the packet as part of the qualifying procedure according to rules to determine whether the packet is eligible to trigger a page request to the user equipment, and sending a page request to the user equipment when the packet is determined to be eligible for transmission and refraining from sending the page request when the packet is determined to be ineligible for transmission.

In yet another embodiment, a gateway in a communication network that receives packets destined for user equipment is described where the gateway is configured qualify the packet to determine whether a page request should be sent to the user equipment by determining which user equipment the packet is destined for and whether the user equipment is in an idle state, and wherein the packet undergoes a qualification procedure based on an inspection according to one or more rules, wherein the gateway refrains from paging the user equipment if the packet is not qualified.

### BRIEF DESCRIPTION OF THE DRAWINGS

FIG. 1 illustrates a network diagram in accordance with certain embodiments;

FIG. 2 illustrates paging initiation in long term evolution (LTE) networks in accordance with certain embodiments;

FIG. 3 illustrates paging initiation in 2G and 3G networks in accordance with certain embodiments;

FIG. 4 illustrates paging initiation in both LTE and 2G/3G networks in accordance with certain embodiments;

FIGS. 5, 6, and 7 illustrate selective paging in accordance with certain embodiments;

FIG. 8 illustrates a flow diagram showing selective paging of rules in a serving gateway (SGW) in accordance with certain embodiments;

FIG. 9 illustrates a flow diagram showing selective paging of rules in a PDN gateway (P-GW) in accordance with certain embodiments;

FIG. 10 illustrates selective paging in a SGW in a LTE network in accordance with certain embodiments;

FIG. 11 illustrates selective paging in a SGW in a 2G/3G network in accordance with certain embodiments;

FIG. 12 illustrates selective paging in a SGW in both LTE and 2G/3G networks in accordance with certain embodiments;

FIG. 13 illustrates selective paging in a P-GW in accordance with certain embodiments;

FIG. 14 illustrates selective paging implemented in both a P-GW and SGW in accordance with certain embodiments; and

FIG. 15 illustrates a chassis in accordance with certain embodiments.

### DETAILED DESCRIPTION

Systems and methods of selective paging in communication systems are described. Pages can be signals sent to a user equipment or mobile device using a Paging Channel (PCH). The paging channel can be a downlink transport channel that permits the transmission of paging indicators, which are used to support sleep-mode procedures of user equipment. The user equipment can have active and idle states to support these sleep-mode procedures, with the idle state allowing for power conservation by only scanning the paging channel for activity. By sending a paging indicator on the paging channel, signaling can be initiated with the user equipment or the user equipment can be prompted to update information or perform some other sort of activity. Paging initiation may also be triggered by downlink data arriving for user equipment. An issue with paging is that it can generate signaling traffic between network devices, and can cause problems when unwanted traffic creates a volume of signaling traffic using limited bandwidth and draining user equipment battery life. In some embodiments, selective paging is used to minimize potential disruptions, to protect against attacks on the network, and to preserve battery life of user equipment.

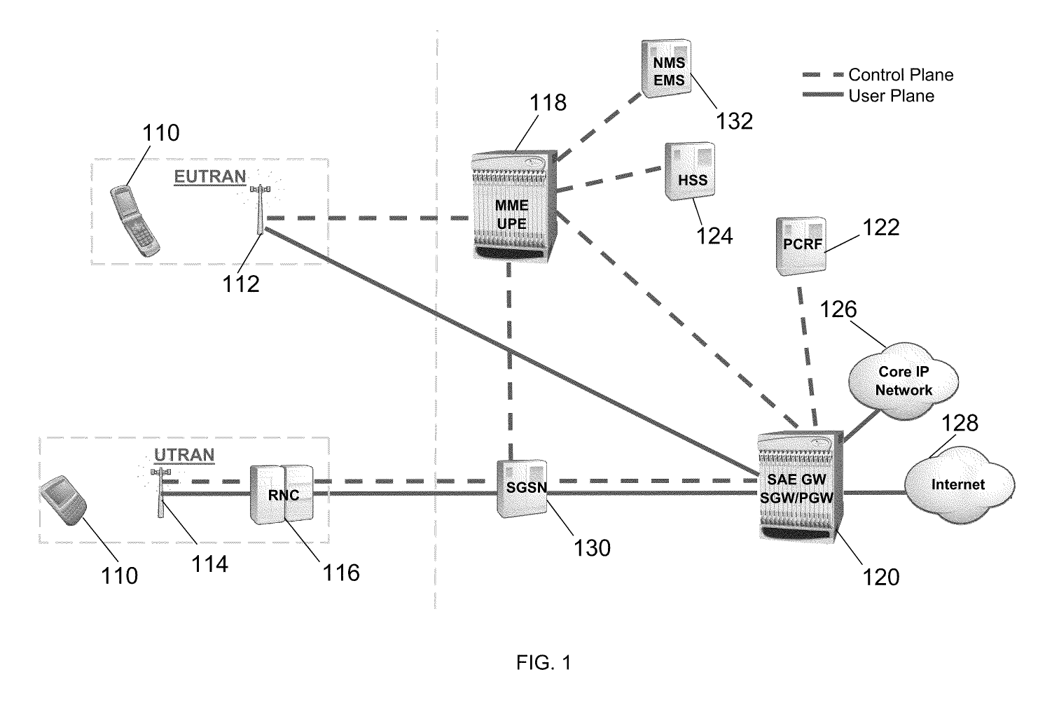

FIG. 1 illustrates a network diagram in accordance with certain embodiments. FIG. 1 illustrates a universal mobile telecommunication system (UMTS) release 8 network along with a LTE network. The network diagram of FIG. 1 includes user equipment (UE) 110, an evolved nodeB (eNB) 112, a nodeB 114, a radio network controller (RNC) 116, a mobility management entity (MME)/user plane entity (UPE) 118, a system architecture evolution gateway (SAE GW) 120, a policy and charging rules function (PCRF) 122, home subscriber server (HSS) 124, core IP network 126, internet 128, Serving General packet radio service Support Node (SGSN) 130, and network management system (NMS)/element management system (EMS) 132. The MME 118, SGSN 130, and SAE GW 120 can be implemented in a gateway as described below. The SAE GW 120 can include a serving gateway (SGW) as well as a packet data network gateway (P-GW). In some embodiments, the SGW and P-GW can be implemented on separate network devices. The main component of the SAE architecture is the Evolved Packet Core (EPC), also known as SAE Core. The EPC includes the MME, SGW and P-GW components. The user equipment (UE) can include a mobile phone, a laptop with wireless connectivity, a netbook, a smartphone, or any other wireless device.

MME 118 is a control-node for the LTE access network. The MME 118 is responsible for UE 110 tracking and paging procedures including retransmissions. MME 118 handles the bearer activation/deactivation process and is also responsible for choosing the SGW for a UE 110 at the initial attach and at time of an intra-LTE handover. The MME 118 also authenticates the user by interacting with the HSS 124. The MME 118 also generates and allocates temporary identities to UEs and terminates Non-Access Stratum (NAS) signaling. The MME 118 checks the authorization of the UE 110 to camp on the service provider's Public Land Mobile Network (PLMN) and enforces UE roaming restrictions. The MME 118 is the termination point in the network for ciphering/integrity protection for NAS signaling and handles the security key management. Lawful interception of signaling is also supported by the MME 118. The MME also provides the control plane function for mobility between LTE and 2G/3G access networks with the S3 interface terminating at the MME 118 from the SGSN 130. The MME 118 also terminates the S6a interface towards the home HSS for roaming UEs.

The SGW routes and forwards user data packets, while also acting as the mobility anchor for the user plane during inter-eNB handovers and as the anchor for mobility between LTE and other 3GPP technologies (terminating S4 interface and relaying the traffic between 2G/3G systems and PDN GW). For idle state UEs, the SGW terminates the down link data path and triggers paging when down link data arrives for the UE 110. The SGW manages and stores UE contexts, e.g. parameters of the IP bearer service and network internal routing information. The SGW also performs replication of the user traffic in case of lawful interception. The P-GW provides connectivity to the UE 110 to external packet data networks by being the point of exit and entry of traffic for the UE 110. A UE 110 may have simultaneous connectivity with more than one P-GW for accessing multiple packet data networks. The P-GW performs policy enforcement, packet filtering for each user, charging support, lawful interception, and packet screening. The P-GW also provides an anchor for mobility between 3GPP and non-3GPP technologies such as WiMAX and 3GPP2 (CDMA 1× and EvDO).

The NMS/EMS 132 can provide management of the operation, administration, maintenance, and provisioning of networked system. Operation deals with keeping the network (and the services that the network provides) up and running smoothly, and includes monitoring to detect problems and minimize disruptions on the network. Administration deals with keeping track of resources in the network and how they are assigned. Maintenance is concerned with performing repairs and upgrades—for example, when equipment must be replaced, when a router needs a patch for an operating system image, when a new switch is added to a network. Provisioning is concerned with configuring resources in the network to support a given service. For example, this might include setting up the network so that a new customer can receive service. Functions that are performed as part of network management accordingly include controlling, planning, allocating, deploying, coordinating, and monitoring the resources of a network, network planning, frequency allocation, predetermined traffic routing to support load balancing, cryptographic key distribution authorization, configuration management, fault management, security management, performance management, bandwidth management, and accounting management. An element management system (EMS) consists of systems and applications that manage network elements (NE) on the network element management layer (NEL) of the Telecommunication Management Network model.

As mentioned above, the user equipment (UE) may be in an active or an idle state. Whether the UE is in an active state can depend on the state of a packet data session, and whether there is an active packet data session. The idle state is a sleep mode state that can be used to conserve battery life of user equipment by minimizing the need to power receivers to be ready for radio signals. The paging indicators are usually broadcast from a number of cells because user equipment may move while in an idle state. For user equipment in an idle state, the SGW can buffer IP packets received for the user equipment and can initiate page requests towards the MME or SGSN. If the user equipment responds to the page, the SGW forwards the IP packet to the eNB in a LTE network or to a RNC/NB or RNC/BS in UMTS/general packet radio service (GPRS) for delivery to the user equipment.

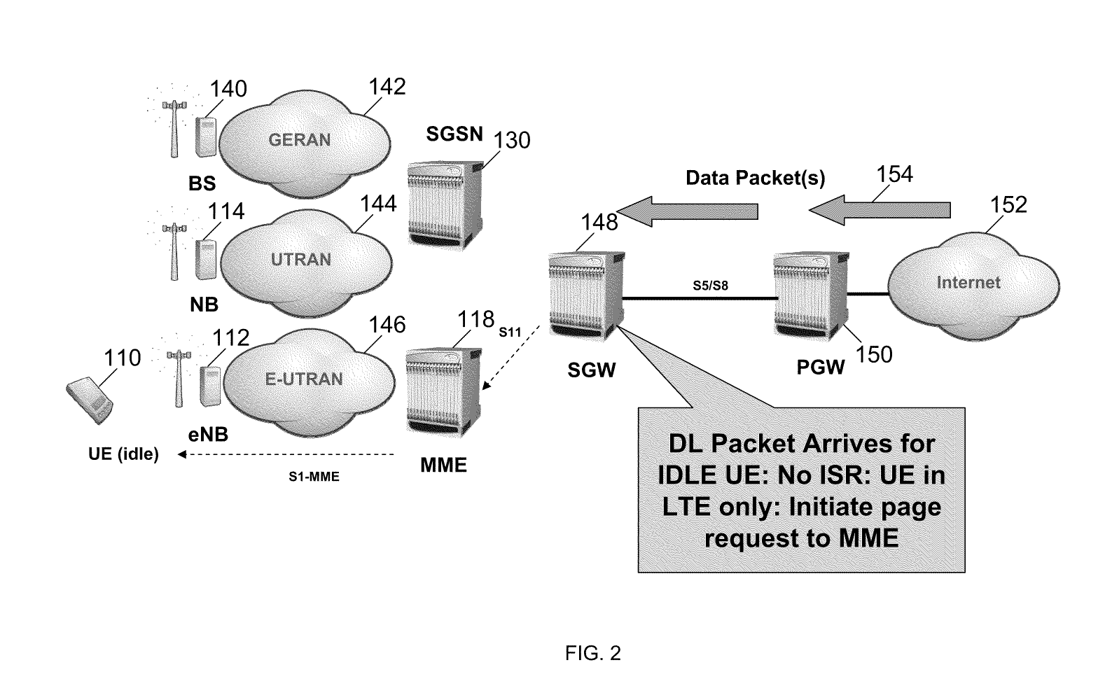

FIG. 2 illustrates paging initiation in long term evolution (LTE) networks in accordance with certain embodiments. FIG. 2 includes user equipment (UE) 110, an evolved Node B (eNB) 112, a node B (NB) 114, a mobility management entity (MME) 118, a serving GPRS support node (SGSN) 130, a base station (BS) 140, a GSM/Edge Radio Access Network (GERAN) 142, a UMTS Terrestrial Radio Access Network (UTRAN) 144, an evolved UMTS Terrestrial Radio Access Network (E-UTRAN) 146, a serving gateway (SGW) 148, a PDN gateway (P-GW) 150, and internet 152. In 154, data packets are sent from internet 152 to P-GW 150 and are forwarded to SGW 148 via an S5/S8 interface. SGW 148 is aware of the state of the UE 110 to which the packets are addressed. Since the UE 110 is in an idle state and the UE 110 is in the LTE network, the packets are buffered at SGW 148 and the SGW 148 initiates a page request to MME 118. MME 118 can send the page request to eNB 112 and the page request reaches the UE 110 that is in an idle state. The page request may be broadcast to other eNBs as well.

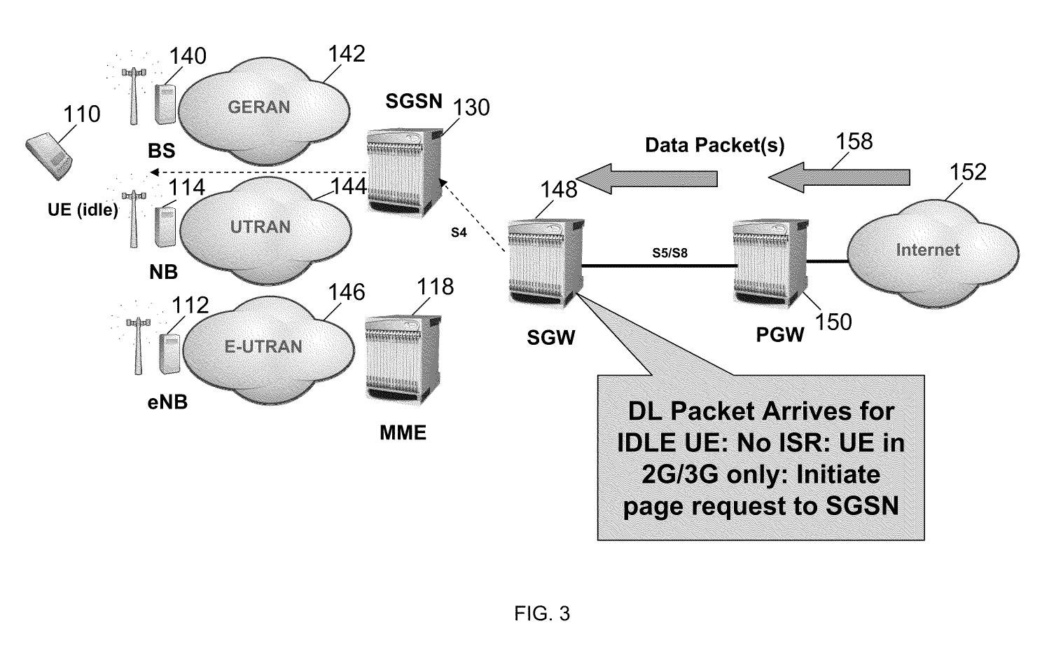

FIG. 3 illustrates paging initiation in 2G and 3G networks in accordance with certain embodiments. FIG. 3 includes user equipment (UE) 110, an evolved Node B (eNB) 112, a node B (NB) 114, a mobility management entity (MME) 118, a serving GPRS support node (SGSN) 130, a base station (BS) 140, a GSM/Edge Radio Access Network (GERAN) 142, a UMTS Terrestrial Radio Access Network (UTRAN) 144, an evolved UMTS Terrestrial Radio Access Network (E-UTRAN) 146, a serving gateway (SGW) 148, a PDN gateway (P-GW) 150, and internet 152. In 158, data packets are sent from internet 152 to SGW 148 via an S4 interface through P-GW 150. Since the UE 110 is in an idle state and the UE 110 is in a 2G/3G network, the packets are buffered at SGW 148 and the SGW 148 initiates a page request to SGSN 130. SGSN 130 can send the page request to either NB 114 or BS 140 and the page request reaches the UE 110 that is in an idle state. The page request may be broadcast to other NBs or BSs as well.

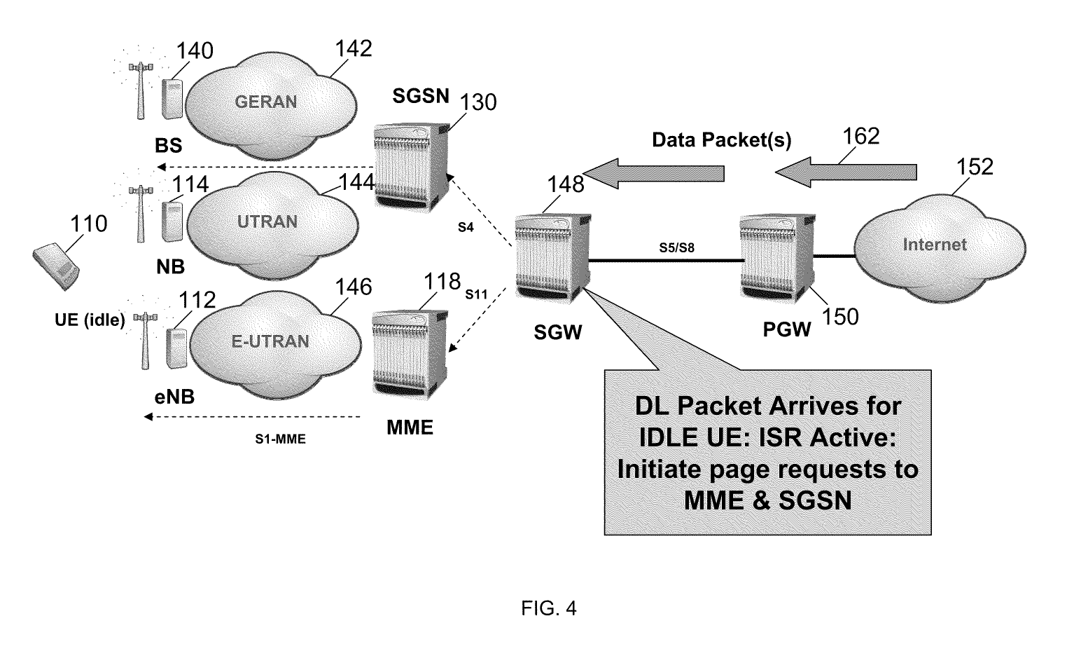

FIG. 4 illustrates paging initiation in both LTE and 2G/3G networks in accordance with certain embodiments. FIG. 4 includes user equipment (UE) 110, an evolved Node B (eNB) 112, a node B (NB) 114, a mobility management entity (MME) 118, a serving GPRS support node (SGSN) 130, a base station (BS) 140, a GSM/Edge Radio Access Network (GERAN) 142, a UMTS Terrestrial Radio Access Network (UTRAN) 144, an evolved UMTS Terrestrial Radio Access Network (E-UTRAN) 146, a serving gateway (SGW) 148, a PDN gateway (P-GW) 150, and internet 152. In 162, data packets are sent from internet 152 to SGW 148 through P-GW 150. The packets are buffered at SGW 148 and a paging request is sent from UE 110, as the UE is in an idle state. Since the UE 110 is active in both the 2G/3G network and LTE network, the SGW 148 initiates a page request to both MME 118 (via an S11 interface) and SGSN 130 (via an S4 interface). MME 118 can send the page request to eNB 112 to reach UE 110, and SGSN 130 can send the page request to either NB 114 or BS 140 to reach UE 110. The page request may be broadcast to other NBs or BSs as well.

Idle mode signaling reduction (ISR) is a feature that allows the UE 110 to roam between LTE and 2G/3G networks. ISR was developed to reduce the frequency of tracking area update (TAU) and routing area update (RAU) procedures caused by UEs reselecting between E-UTRAN 146 and GERAN/UTRAN 144, which are operated together in some embodiments. The ISR feature allows the UE 110 to register in an UTRAN/GERAN RA (routing area) at the same time it is registered in an E-UTRAN TA (tracking area) or list of TAs. The UE and the network can maintain the two registrations in parallel and run periodic timers for both registrations independently ensuring that the UE can be paged in both the RA and the TA. When ISR is activated, the UE 110 is registered with both MME 118 and SGSN 130 and both are in communication with the SGW 148. The UE 110 can store mobility management parameters from SGSN 130 (e.g., P-TMSI and RA) and from MME 118 (e.g., GUTI and TA(s)) along with session management (bearer) contexts that are common for E-UTRAN and GERAN/UTRAN access. Then in idle state, the UE can reselect between E-UTRAN and GERAN/UTRAN (within the registered RA and TAs) without performing TAU or RAU procedures with the network.

Even if idle mode signaling reduction is enabled, the page initiation triggered by downlink data for idle state UEs causes a volume of signaling traffic between SGW 148 and MME 118/SGSN 130. Typically, SGW 148 initiates paging for any received data packets. However, this provides no protection from unwanted traffic from, e.g., untrusted sources, which can create signaling that reduces network capacity and drains the UE's battery life. In a worst case scenario, an attack can overwhelm the network and cause a failure. Further, the operator may not be able to bill for delivery of unwanted packets to the UE, if there is any dispute, so operators may also lose revenue or have to deal with frustrated customers and the accounting/billing system. Further, the network can be susceptible to many denial of service (DoS) attacks, if the SGW does not check packets before initiating a page request.

In some embodiments, hardware or software in a gateway implementing a SGW or P-GW can apply a rules based packet qualification to determine whether a packet triggers a page notification of a UE when the UE is in an idle state. Embodiments implemented in a SGW are aware of the state of a UE, as this information is kept in a SGW, but other embodiments are possible. When rules based packet qualification is implemented, page requests towards the MME/SGSN are only initiated when a packet passes the qualification process. Packets that do not qualify may be discarded. In certain embodiments, the rules provide for buffering packets for a predetermined period of time or until a predetermined size is collected. These packets may also need to meet certain parameters to qualify them and avoid being discarded. The advantage of buffering a number of packets is that signaling can be reduced. The logic can also be used to discard redundant packets, such as ones that are already waiting in a buffer.

In some embodiments, the packets can also be flagged, marked, or otherwise appended with additional information. The SGW can mark or append bearer information on the packet and send the packet onto the MME or SGSN for further processing and/or decision making This can be advantageous because the MME/SGSN can be aware of the bandwidth available on the paging channel and other information that is not available to the SGW. Also the SGW has information, such as bearer information, that may not be available to the MME/SGSN.

By marking the packet, information can be passed to the MME/SGSN so a more informed decision can be made using the combined information available at both the SGW and the MME/SGSN. For example, the SGW can append information such as whether the packet is packet for a voice connection, such as voice over IP (VoIP), or some other type of packet, such as an Internet originate packet. This can allow an operator to make more intelligent decisions regarding attacks that undermine the limited bandwidth of the radio access interface. For example, if the paging channel is becoming congested to the point were packets will be dropped, the MME/SGSN can make a decision to drop an Internet-based packet rather than dropping a voice connection packet. In this embodiment, the MME/SGSN can be modified to receive rules from the PCRF or other policy server, or be manually configured with rules. The rules can be used to determine how marked packets are handled by the MME/SGSN. The network can also be setup so that certain packets are simply dropped at the SGW, some packets trigger paging, and the remaining packets are marked for the MME/SGSN to make a final determination on the packet. The MME/SGSN can then decide whether to page the UE or drop the packet.

The provisioning of the policy can be either directly configurable in the SGW or PGW or allow a policy and charging rules function (PCRF) to include default rules for selective paging. The rules can be applied to packet header fields layer 3 to layer 7 based on either shallow or deep packet inspection. The type of inspection implemented can depend on the rule. Shallow packet inspection (SPI) can be an inspection involving the packet header, while deep packet inspection (DPI) involves inspecting the packet payload or perhaps packet headers that are encapsulated in the payload of the packet. The actions performed during packet inspections and the type of inspection (e.g., SPI versus DPI) can be based upon the rules being used to qualify the packet. The type of rules applied to a packet can depend on a variety of factors, such as the port receiving the packet, the connection that the packet is received on, or other information. For example, packets arriving on certain ports or over certain types of connections have specific rules applied on the basis of the port the packet is received on because only certain applications use that port. Since the gateway can determine certain things on the basis of how a packet is received, the rules applied to the packet can be tailored to the likely traffic that is received by a particular port or connection.

The rules applied to a packet can also be based upon other inherent characteristics of the packet that are known prior to an inspection of the packet. An inspection of a packet may also trigger the application of other rules. For example, a shallow packet inspection that reveals a particular source address can trigger a deep packet inspection to determine further information about the packet. The rules can also allow paging, buffer packet for later paging, or discard the packet. Other conditions are also permitted. If the rules are manually provisioned, the data structure of the rule can be implementation specific. The rules applied can also be dynamically provisioned so they are unique on a per-user basis and even unique on a time basis. The rules can be unique on a time basis when the selective paging mechanism is used in conjunction with a distributed denial of service (DDoS) attack or DoS attack detection mechanism. DDoS/DoS attack mechanism can be used to determine when nodes in the network are being bombarded by higher than normal traffic from one or more hosts. This information can then be provided to modify rules in real time to drop packets that are from these hosts, or to perform deep packet inspection to determine whether the packet is a genuine user packet, rather than a packet manufactured for an attack on the network.

In some embodiments, the selective paging mechanism is implemented on a gateway that is aware of the status of the user equipment. The status information can include whether the UE is active or idle. Knowing the status of the UE, the SGW can avoid unnecessary inspection of packets. For example, by dropping a packet before setting up an air interface/airlink connection, use of these resources can be avoided. Additionally, after a connection is setup and the UE is active, the gateway no longer needs to perform inspection on packets. This can reduce the processing burdens that would otherwise entail from inspecting each packet that flows through the gateway. In some embodiments, by detecting packets involved in a DoS/DDoS attack and avoiding the setup of an airlink, the impact of the attack can be minimized by using minimal resources. For example, if each packet was to be inspected by the gateway, then a DoS/DDoS attack could possibly overload the gateway by increasing the processing burdens of inspection and causing congestion at the gateway.

The selective paging mechanism can also be based on user or network operator preferences. Generally, when a packet data network (PDN) connection is open on the gateway for a UE, packets arriving on the PDN connection when the UE is in an idle state can trigger a paging request to the UE. By providing selective paging, the user or the network operator can control the types of messages that are allowed to page the UE and setup a data connection. Certain applications are chatty and send many updates, advertisements, or messages to a user, such as twitter, blogs, weather applications, etc. The user may not want to be receiving these messages and can setup a profile to limit the messages received. The profile can be set based on a variety of attributes such as time of day, location, type of data, source application, etc. This selective paging can be helpful, for example, when the user is roaming in a foreign country and does not want to be stuck with expensive data charges for certain applications.

The selective paging mechanism can provide a mechanism for selectively limiting the data received, while not having to turn off data service. For example, a user can adjust a profile to limit personal applications from sending data, and limit email updates so that data charges can be contained. Also, companies can setup profiles to limit personal use of devices during business hours by selectively limiting paging traffic. In addition, since UE state information is used this reduces the amount of processing that is needed to implement the selective paging because only packets that would trigger a paging request are inspected in some embodiments. The profile can also be setup to limit advertisements or other information the user would prefer to block. The profile can be setup on the user equipment or through a portal such as a webpage. The profile can be linked to the subscriber profile for the use and stored in a network device such as a PCRF, an authentication, authorization, and accounting (AAA) server, or a HSS.

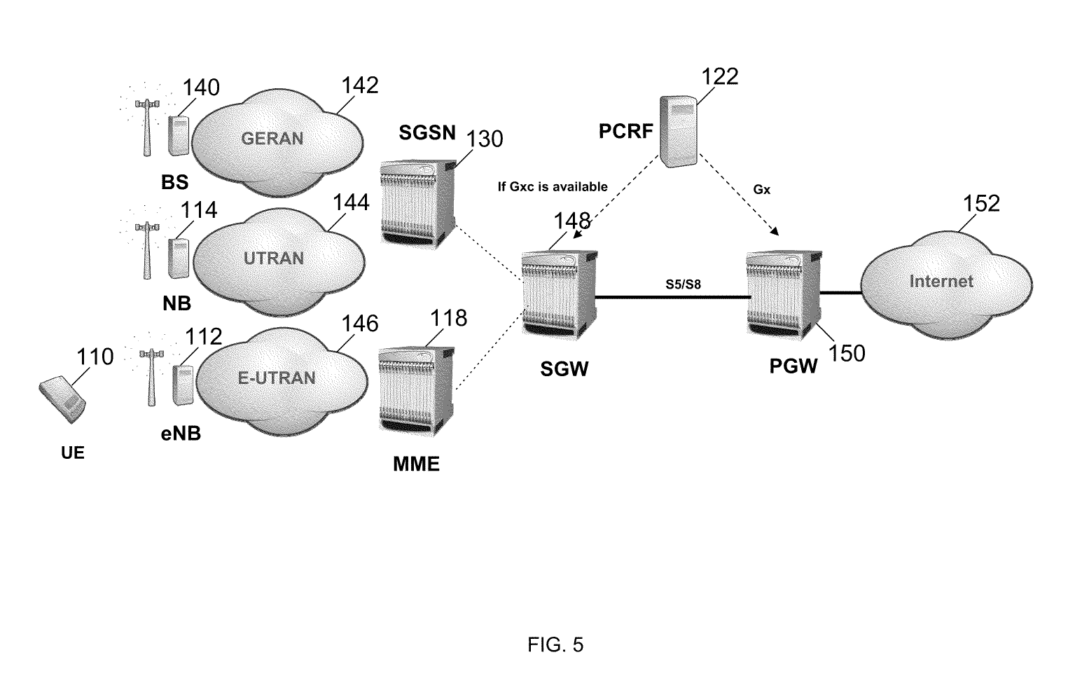

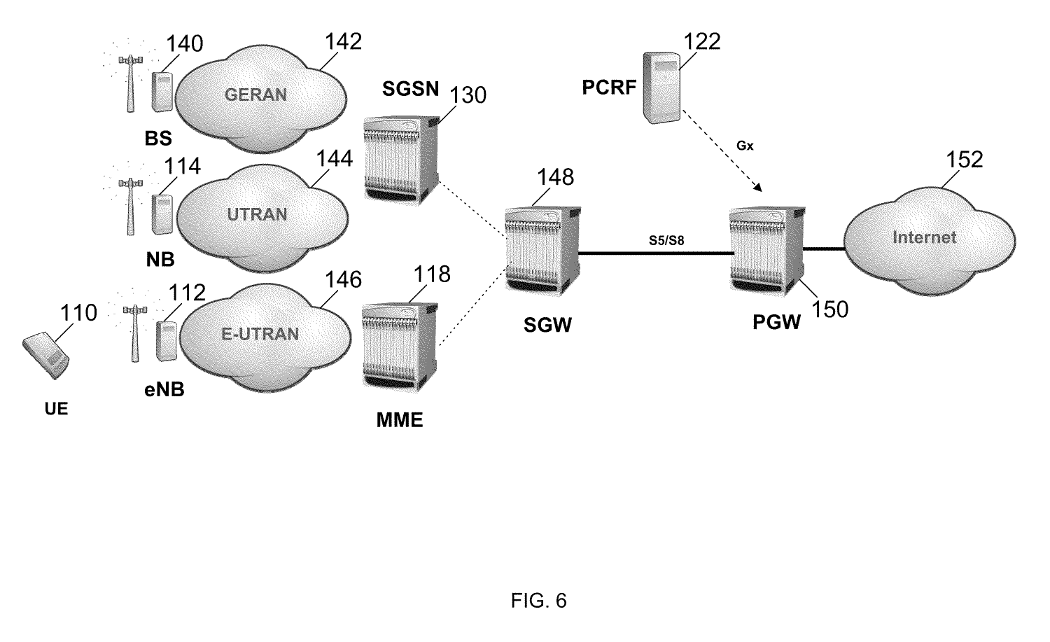

FIGS. 5, 6, and 7 illustrate selective paging in accordance with certain embodiments. FIGS. 5 and 6 include user equipment (UE) 110, an evolved Node B (eNB) 112, a node B (NB) 114, a mobility management entity (MME) 118, a policy and charging rules function (PCRF) 122, a serving GPRS support node (SGSN) 130, a base station (BS) 140, a GSM/Edge Radio Access Network (GERAN) 142, a UMTS Terrestrial Radio Access Network (UTRAN) 144, an evolved UMTS Terrestrial Radio Access Network (E-UTRAN) 146, a serving gateway (SGW) 148, a PDN gateway (P-GW) 150, and internet 152. In FIG. 5, UE 110 attaches and activates the default bearer. PCRF 122 downloads the default selective paging rule set to P-GW 150 and SGW 148. This can be done using Gx and Gxc interfaces in some embodiments. In FIG. 6, the UE 110 attaches and activates the default bearer. PCRF 122 downloads default selective paging rule set to PGW 150. SGW 148 is provisioned with static selective paging rules.

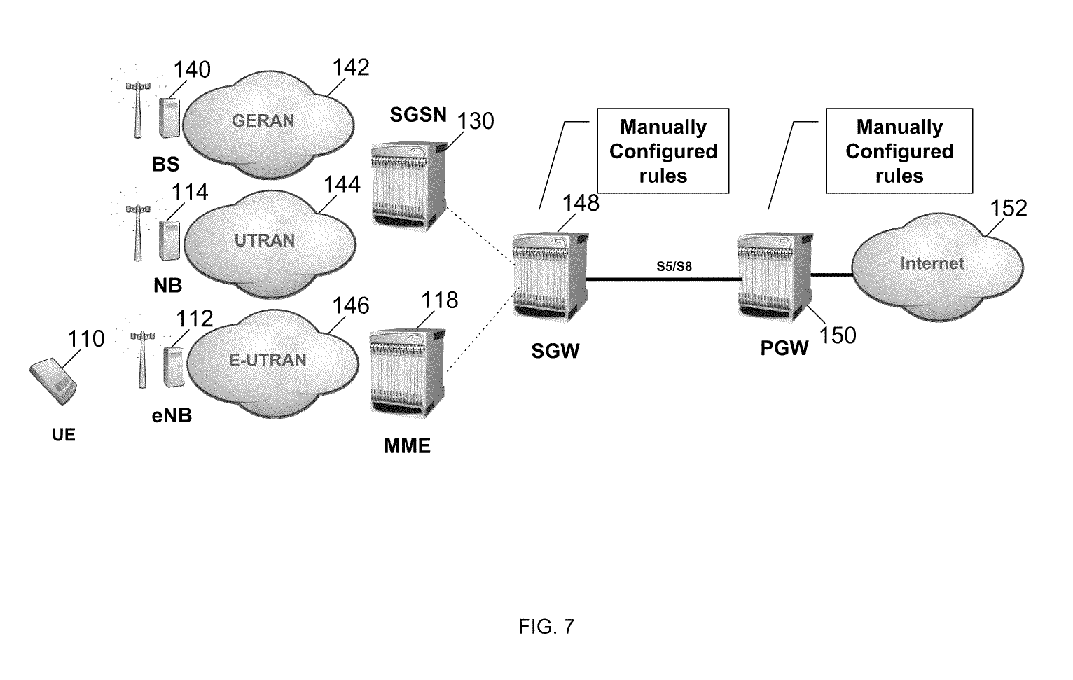

FIG. 7 includes user equipment (UE) 110, an evolved Node B (eNB) 112, a node B (NB) 114, a mobility management entity (MME) 118, a serving GPRS support node (SGSN) 130, a base station (BS) 140, a GSM/Edge Radio Access Network (GERAN) 142, a UMTS Terrestrial Radio Access Network (UTRAN) 144, an evolved UMTS Terrestrial Radio Access Network (E-UTRAN) 146, a serving gateway (SGW) 148, a PDN gateway (P-GW) 150, and internet 152. In FIG. 7, the SGW 148 and P-GW 150 are manually provisioned with selective paging rules. Manual provisioning can be implemented with a command line interface or a graphical user interface and can involve a person entering the rules directly to the equipment. The rules can apply to groups of users, through the use of one or more attributes that identify the UE, or can apply to all sessions at a particular SGW 148 or P-GW 150.

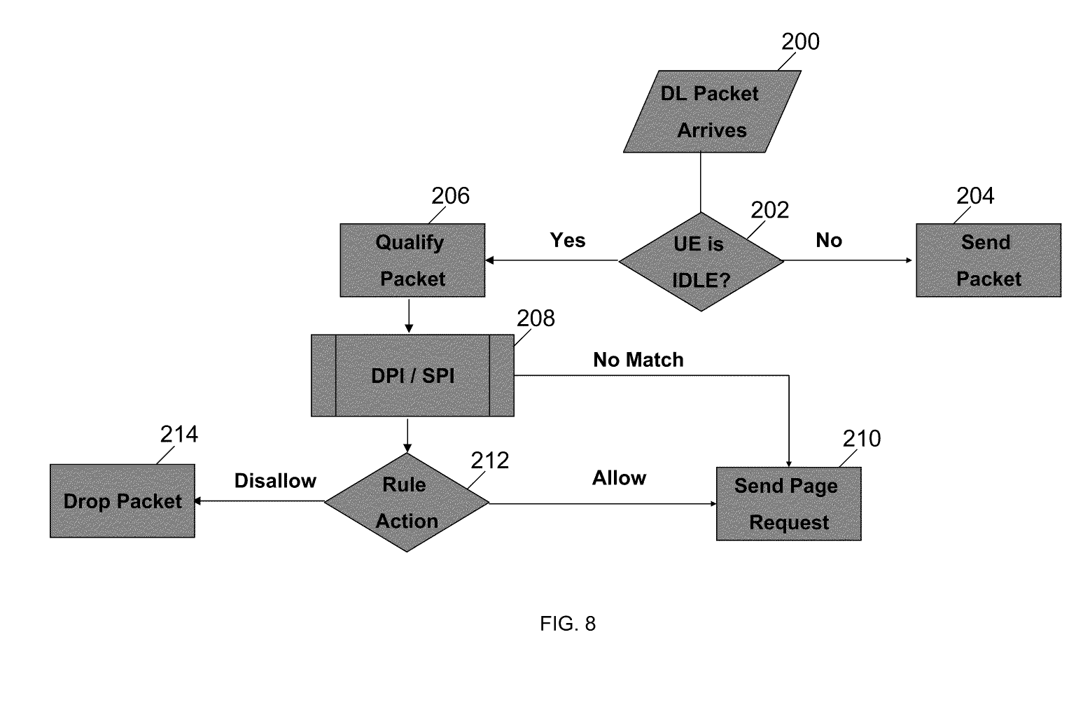

FIG. 8 illustrates a flow diagram showing selective paging with rules in a serving gateway (SGW) in accordance with certain embodiments. At 200, a packet arrives at a SGW, which has access to the state information of the UEs that have a session with the SGW. In 202, the SGW determines if the UE to which the packet is addressed is idle. If the UE is active, the SGW sends the packet to the UE in 204. If the UE is idle, the SGW engages in a step of qualifying the packet in 206. In 208, deep packet inspection (DPI) and/or shallow packet inspection (SPI) is conducted on the packet. If the inspection of the packet header produces no match any of the rules, then a page request can be sent to the UE in 210. If the inspection of the packet header does produce a rule match, in 212, then a decision is made based on the action described by the rule. If the rule allows for sending the packet to the UE, a page request is sent to the UE in 210. If the rule does not allow for sending the packet, the packet can be dropped in 214.

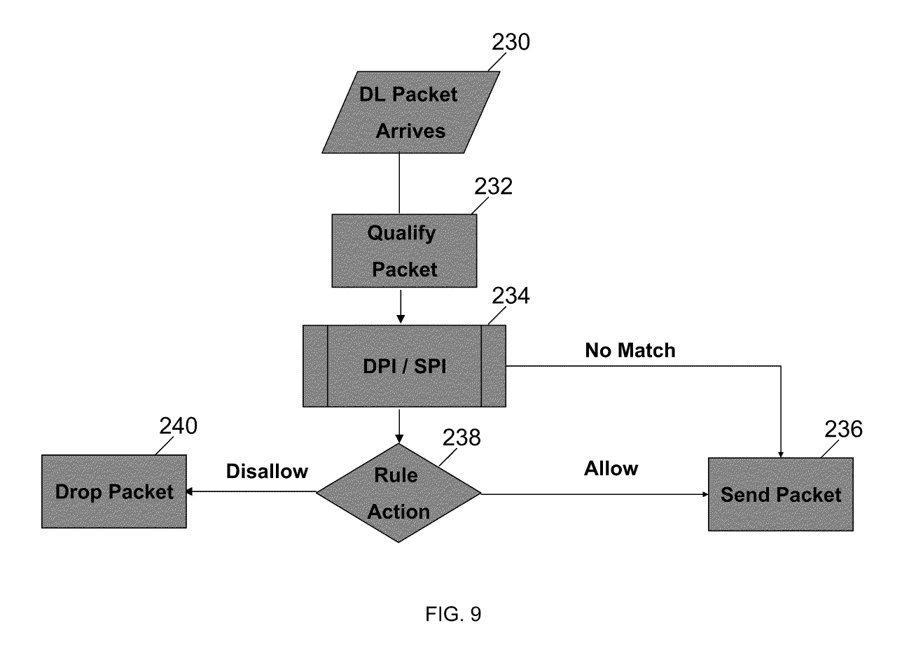

FIG. 9 illustrates a flow diagram showing selective paging of rules in a PDN gateway (P-GW) in accordance with certain embodiments. At 230, a packet arrives at a P-GW with an address of a UE in the network handled by the P-GW. The P-GW qualifies the packet in 232 by performing deep packet inspection (DPI) and/or shallow packet inspection (SPI) on the header of the packet at 234. If the inspection of the packet header produces no match any of the rules, then the packet can be sent to the SGW in 236. Otherwise, if the inspection of the packet header does produce a rule match, in 238, then a decision is made based on the action described by the rule. If the rule allows for sending the packet to the UE then the packet is sent on to the SGW in 236. If the rule does not allow for sending the packet, the packet can be dropped in 240.

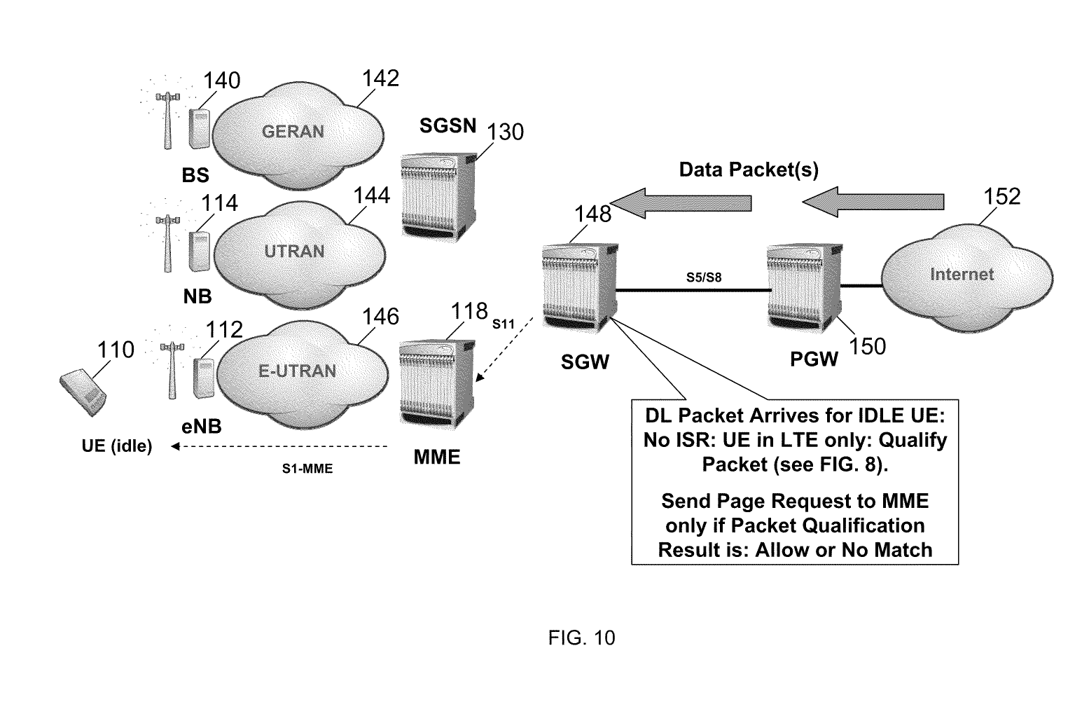

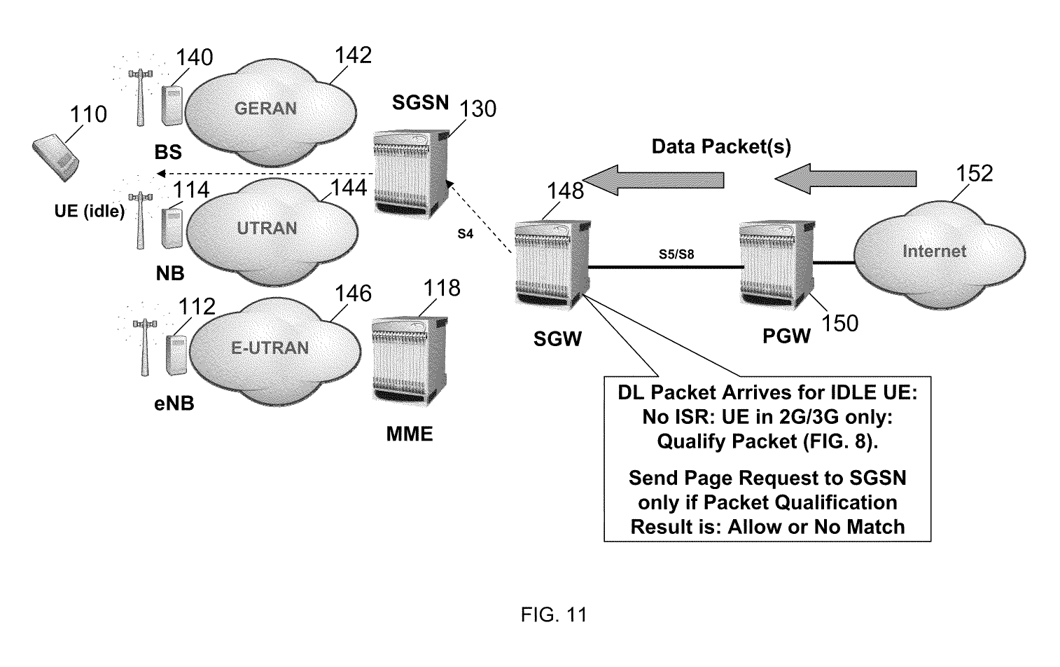

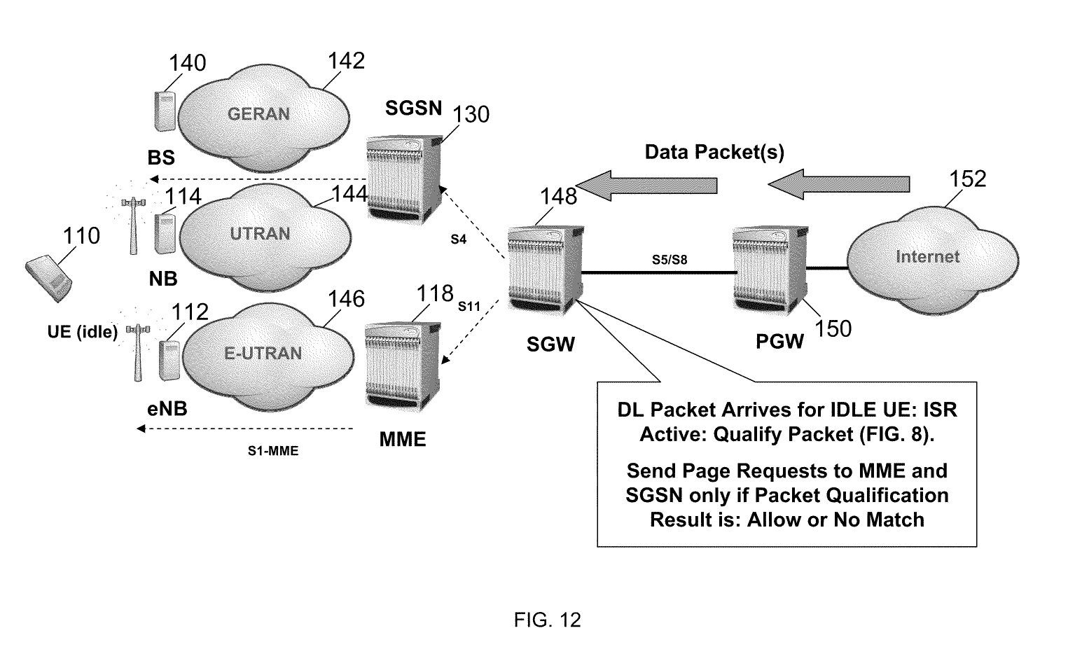

FIG. 10 illustrates selective paging in a SGW in a LTE network in accordance with certain embodiments. FIGS. 10-14 include user equipment (UE) 110, an evolved Node B (eNB) 112, a node B (NB) 114, a mobility management entity (MME) 118, a serving GPRS support node (SGSN) 130, a base station (BS) 140, a GSM/Edge Radio Access Network (GERAN) 142, a UMTS Terrestrial Radio Access Network (UTRAN) 144, an evolved UMTS Terrestrial Radio Access Network (E-UTRAN) 146, a serving gateway (SGW) 148, a PDN gateway (P-GW) 150, and internet 152. In FIG. 10, a packet arrives at SGW 148 destined for an idle UE 110. SGW 148 can determine that UE 110 is idle, as SGW 148 has access to the state information of UEs attached to it. The packet is qualified and a page request is sent to MME 118 if the packet is determined to be eligible for paging to be initiated. FIG. 11 illustrates selective paging in a SGW in a 2G/3G network in accordance with certain embodiments. In FIG. 11, a packet arrives at SGW 148 destined to idle UE 110. The packet undergoes qualification and a page request is sent to SGSN 130 if the packet is determined to be eligible for paging to be initiated. FIG. 12 illustrates selective paging in a SGW in both LTE and 2G/3G networks in accordance with certain embodiments. In FIG. 12, idle state signaling reduction (ISR) is active and an incoming packet is qualified to check whether the packet is eligible for paging. A page request is sent to MME 118 and SGSN 130 if the packet is eligible for paging. In some embodiments, the rules can allow a packet to be buffered until a trigger sends page request and then all the buffered packets to the UE 110.

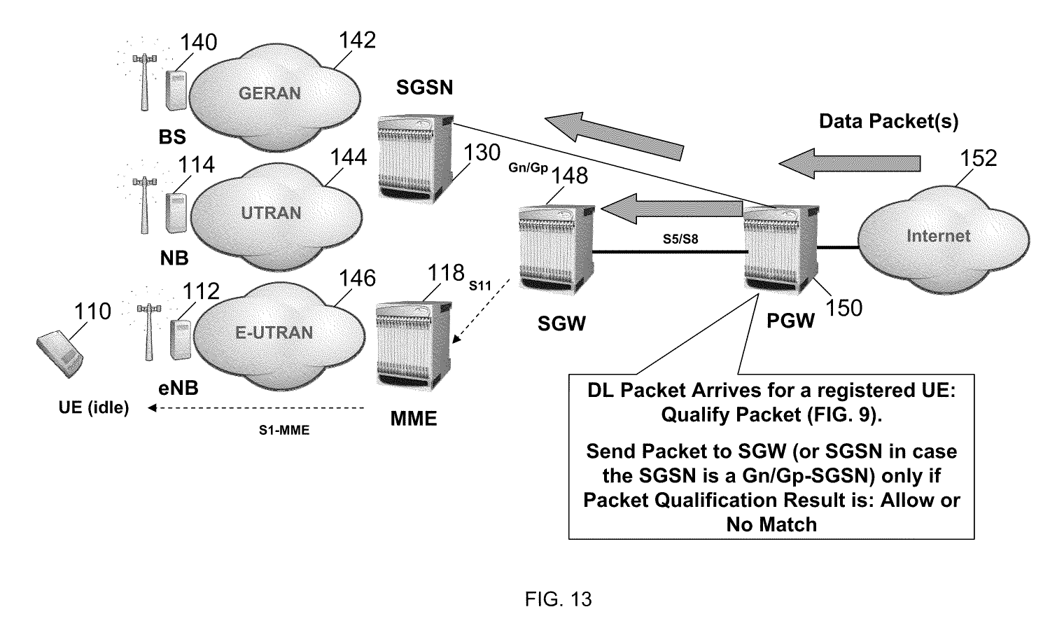

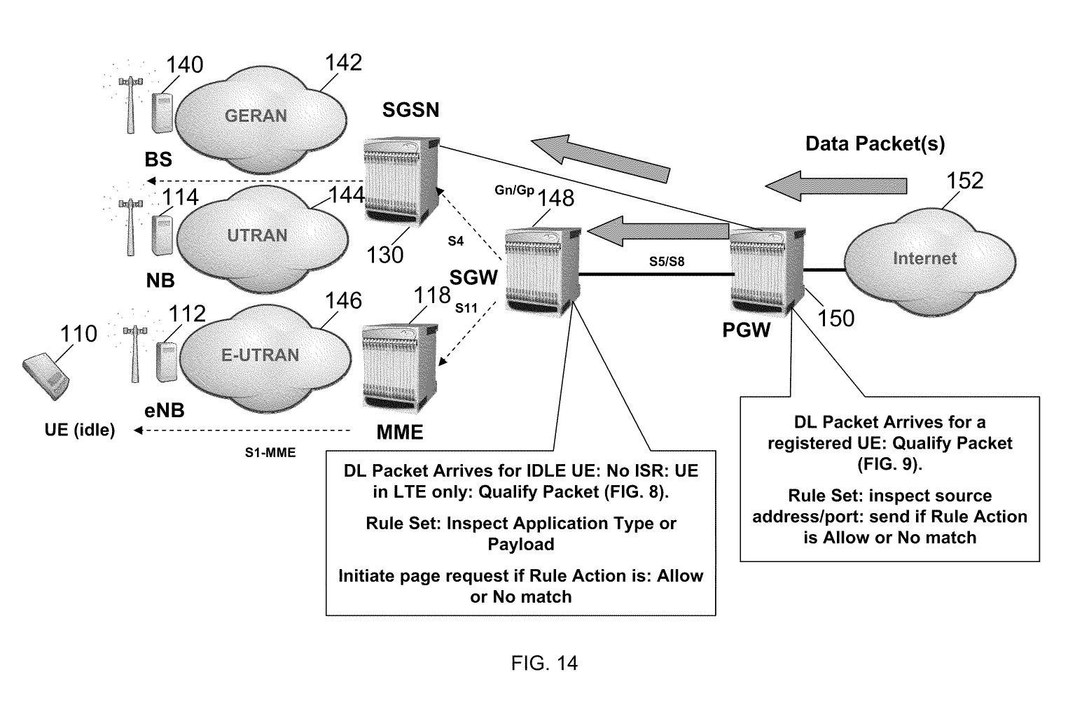

FIG. 13 illustrates selective paging in a P-GW in accordance with certain embodiments. In FIG. 13, a packet can be qualified by P-GW 150. In some embodiments this the rules to qualify a packet for selective paging can be state independent. The P-GW 150 can also send directly to the SGSN if the SGSN is enabled with a Gn/Gp interface and the packet is eligible. In some embodiments, selective paging rules are applied simultaneously in both the SGW and the P-GW. By applying qualification rules at both the SGW and the P-GW, various configurations can be developed. For example, different rules can be configured in the SGW and P-GW such as the P-GW looking at the source address/port of a packet and the SGW inspecting the application type of the packet. This can allow unwanted packets to be discarded earlier and not use bandwidth and resources between the P-GW and SGW. FIG. 14 illustrates selective paging implemented in both a P-GW and a SGW in accordance with some embodiments. As shown in FIG. 14, P-GW 150 qualifies the packet by inspecting the source address/port of the packet and SGW 148 qualifies the packet by inspecting the application type or payload.

In some embodiments, the rules can be formatted to use the Gx interface protocol to communicate rules that apply to selective paging from a policy and charging rules function (PCRF) to a PDN gateway (P-GW). The Gx interface protocol is used for the provisioning and removal of rules sent from the PCRF to the P-GW and the transmission of traffic plane events from the P-GW to the PCRF. If the Gx interface or a similar protocol is used, then the rules can be applied according to conditions set by the operator and the rules can be uploaded when selective paging is desired. The P-GW can select a rule for each received packet by evaluating received packets against service data flow filters of the rules in the order of the precedence of the rules. When a packet matches a service data flow filter, the packet matching process for that packet is completed, and the rule for that filter can be applied. The rules can be dynamically provisioned or predefined. Dynamically provisioned rules are communicated by the PCRF to the P-GW. These rules may be either predefined or dynamically generated in the PCRF. Dynamic rules can be activated, modified, or deactivated at any time. Predefined rules can be activated or deactivated by the PCRF at any time. Predefined rules within the P-GW may be grouped allowing the PCRF to dynamically trigger activation of a set of rules. In some embodiments, a rule comprises one of more of the following: a rule name, service identifier, service data flow filter(s), precedence, gate status, QoS parameters, charging key (i.e. rating group), other charging parameters. In some embodiments, a Gxc or other similar interface protocol can be used with the SGW to provision and remove rules from the SGW.

The mobile device or user equipment described above can communicate with a plurality of radio access networks (including eNodeBs) using a plurality of access technologies. The user equipment can be a smartphone offering advanced capabilities such as word processing, web browsing, gaming, e-book capabilities, an operating system, and a full keyboard. The user equipment may run an operating system such as Symbian OS, iPhone OS, RIM's Blackberry, Windows Mobile, Linux, Palm WebOS, and Android. The screen may be a touch screen that can be used to input data to the mobile device and the screen can be used instead of the full keyboard. The user equipment may have the capability to run applications or communicate with applications that are provided by servers in the communication network.

The user equipment can receive updates and other information from these applications on the network. The user equipment can also keep global positioning coordinates, profile information, or other location information in its stack or memory. A profile regarding selective paging can be setup on the user equipment and communicated to the network for enforcement, in some embodiments. The user equipment can also use messaging to report back conditions to the network, for example, during an attack on the network. The user equipment can report information regarding whether a packet received was a genuine packet or possibly the result of a network attack. This information can then be used by the network to modify rules for selective page to prevent the attack from spreading to other user equipment.

The user equipment can include one or more antennas that are configured to transmit and receive data on a radio frequency with a plurality of radio access networks and/or access technologies. The one or more antennas can be used to send and receive data flows over a plurality of access technologies. The mobile device can be configured with one or more processors that process instructions including processing a first data flow and a second data flow received from the at least one antenna. The processors can also communicate with a computer readable medium used for storage such as programmable read only memory. The processor can be any applicable processor such as a system-on-a-chip that combines a CPU, an application processor, and flash memory. A processor can also compile user preferences regarding how certain types of data flows are transmitted to the mobile device and communicate these preferences to the network, such as the access gateway.

The gateway described above is implemented in a chassis in some embodiments. This chassis can implement multiple and different integrated functionalities. In some embodiments, a mobility management entity (MME), a PDN gateway (P-GW), a serving gateway (SGW), an access gateway, a HRPD serving gateway (HSGW), a packet data serving node (PDSN), a foreign agent (FA), or home agent (HA) can be implemented on a chassis. Other types of functionalities can also be implemented on a chassis in other embodiments are a Gateway General packet radio service Serving Node (GGSN), a serving GPRS support node (SGSN), a packet data inter-working function (PDIF), an access service network gateway (ASNGW), a base station, a access network, a User Plane Entity (UPE), an IP Gateway, an access gateway, a session initiation protocol (SIP) server, a proxy-call session control function (P-CSCF), and an interrogating-call session control function (I-CSCF), a serving gateway (SGW), and a packet data network gateway (PDN GW). In certain embodiments, one or more of the above-mentioned other types of functionalities are integrated together or provided by the same functionality. For example, an access network can be integrated with a PDSN. A chassis can include a PDSN, a FA, a HA, a GGSN, a PDIF, an ASNGW, a UPE, an IP Gateway, an access gateway, or any other applicable access interface device. In certain embodiments, a chassis is provided by Starent Networks, Corp. of Tewksbury, Mass. in a ST16 or a ST40 multimedia platform.

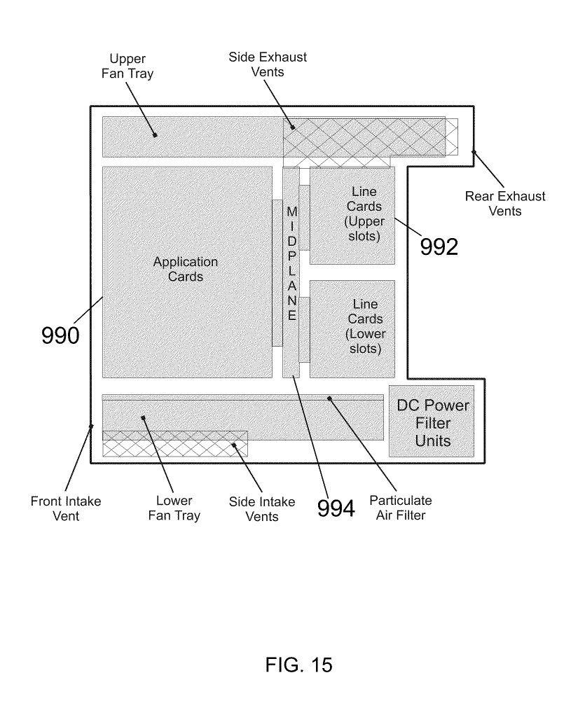

The features of a chassis that implements a gateway, in accordance with some embodiments, are further described below. FIG. 15 illustrates positioning of cards in the chassis in accordance with some embodiments. The chassis includes slots for loading application cards 990 and line cards 992. A midplane 994 can be used in the chassis to provide intra-chassis communications, power connections, and transport paths between the various installed cards. The midplane 994 can include buses such as a switch fabric, a control bus, a system management bus, a redundancy bus, and a time division multiplex (TDM) bus. The switch fabric is an IP-based transport path for user data throughout the chassis implemented by establishing inter-card communications between application cards and line cards. The control bus interconnects the control and management processors within the chassis. The chassis management bus provides management of system functions such as supplying power, monitoring temperatures, board status, data path errors, card resets, and other failover features. The redundancy bus provides transportation of user data and redundancy links in the event of hardware failures. The TDM bus provides support for voice services on the system.

The chassis supports at least four types of application cards: a switch processor card, a system management card, a packet service card, and a packet accelerator card. The switch processor card serves as a controller of the chassis and is responsible for such things as initializing the chassis and loading software configurations onto other cards in the chassis. The packet accelerator card provides packet processing and forwarding capabilities. Each packet accelerator card is capable of supporting multiple contexts. Hardware engines can be deployed with the card to support parallel distributed processing for compression, classification traffic scheduling, forwarding, packet filtering, and statistics compilations. The system management card is a system control and management card for managing and controlling other cards in the gateway device. The packet services card is a high-speed processing card that provides mutli-threaded point-to-point, packet data processing, and context processing capabilities, among other things.

The packet accelerator card performs packet-processing operations through the use of control processors and a network processing unit. The network processing unit determines packet processing requirements; receives and transmits user data frames to/from various physical interfaces; makes IP forwarding decisions; implements packet filtering, flow insertion, deletion, and modification; performs traffic management and traffic engineering; modifies/adds/strips packet headers; and manages line card ports and internal packet transportation. The control processors, also located on the packet accelerator card, provide packet-based user service processing. The line cards when loaded in the chassis provide input/output connectivity and can also provide redundancy connections as well.

The operating system software can be based on a Linux software kernel and run specific applications in the chassis such as monitoring tasks and providing protocol stacks. The software allows chassis resources to be allocated separately for control and data paths. For example, certain packet accelerator cards can be dedicated to performing routing or security control functions, while other packet accelerator cards are dedicated to processing user session traffic. As network requirements change, hardware resources can be dynamically deployed to meet the requirements in some embodiments. The system can be virtualized to support multiple logical instances of services, such as technology functions (e.g., a PDN GW, SGW, MME, PDSN, ASNGW, PDIF, HA, GGSN, or IPSG).

The chassis' software can be divided into a series of tasks that perform specific functions. These tasks communicate with each other as needed to share control and data information throughout the chassis. A task is a software process that performs a specific function related to system control or session processing. Three types of tasks operate within the chassis in some embodiments: critical tasks, controller tasks, and manager tasks. The critical tasks control functions that relate to the chassis' ability to process calls such as chassis initialization, error detection, and recovery tasks. The controller tasks mask the distributed nature of the software from the user and perform tasks such as monitor the state of subordinate manager(s), provide for intra-manager communication within the same subsystem, and enable inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem can include critical tasks, controller tasks, and manager tasks. Some of the subsystems that can run on a chassis include a system initiation task subsystem, a high availability task subsystem, a recovery control task subsystem, a shared configuration task subsystem, a resource management subsystem, a virtual private network subsystem, a network processing unit subsystem, a card/slot/port subsystem, and a session subsystem.

The system initiation task subsystem is responsible for starting a set of initial tasks at system startup and providing individual tasks as needed. The high availability task subsystem works in conjunction with the recovery control task subsystem to maintain the operational state of the chassis by monitoring the various software and hardware components of the chassis. Recovery control task subsystem is responsible for executing a recovery action for failures that occur in the chassis and receives recovery actions from the high availability task subsystem. Shared configuration task subsystem provides the chassis with an ability to set, retrieve, and receive notification of chassis configuration parameter changes and is responsible for storing configuration data for the applications running within the chassis. Resource management subsystem is responsible for assigning resources (e.g., processor and memory capabilities) to tasks and for monitoring the task's use of the resources.

Virtual private network (VPN) subsystem manages the administrative and operational aspects of VPN-related entities in the chassis, which include creating separate VPN contexts, starting IP services within a VPN context, managing IP pools and subscriber IP addresses, and distributing the IP flow information within a VPN context. In some embodiments, within the chassis, IP operations are done within specific VPN contexts. The network processing unit subsystem is responsible for many of the functions listed above for the network processing unit. The card/slot/port subsystem is responsible for coordinating the events that occur relating to card activity such as discovery and configuration of ports on newly inserted cards and determining how line cards map to application cards. The session subsystem is responsible for processing and monitoring a mobile subscriber's data flows in some embodiments. Session processing tasks for mobile data communications include: A10/A11 termination for CDMA networks, GSM tunneling protocol termination for GPRS and/or UMTS networks, asynchronous PPP processing, packet filtering, packet scheduling, Difsery codepoint marking, statistics gathering, IP forwarding, and AAA services, for example. Responsibility for each of these items can be distributed across subordinate tasks (called managers) to provide for more efficient processing and greater redundancy. A separate session controller task serves as an integrated control node to regulate and monitor the managers and to communicate with the other active subsystem. The session subsystem also manages specialized user data processing such as payload transformation, filtering, statistics collection, policing, and scheduling.

In some embodiments, the software needed for implementing a process or a database includes a high level procedural or an object-orientated language such as C, C++, C#, Java, or Perl. The software may also be implemented in assembly language if desired. Packet processing implemented in a chassis can include any processing determined by the context. For example, packet processing may involve high-level data link control (HDLC) framing, header compression, and/or encryption. In certain embodiments, the software is stored on a storage medium or device such as read-only memory (ROM), programmable-read-only memory (PROM), electrically erasable programmable-read-only memory (EEPROM), flash memory, or a magnetic disk that is readable by a general or special purpose-processing unit to perform the processes described in this document.

Although the present invention has been described and illustrated in the foregoing exemplary embodiments, it is understood that the present disclosure has been made only by way of example, and that numerous changes in the details of implementation of the invention may be made without departing from the spirit and scope of the invention, which is limited only by the claims which follow. Other embodiments are within the following claims. For example, the mobility management entity can be combined or co-located with the serving gateway.

We claim:

1. A gateway in a communication network that receives packets destined for user equipment comprising:
an interface configured to receive a packet destined toward a user equipment; and
an interface configured to initiate a page request,
wherein the gateway is configured to determine, based on information from the packet, which user equipment the packet is destined for and for qualifying the packet to initiate a page request to the user equipment, wherein the packet is qualified when the user equipment is in an idle state and wherein the packet passes a qualification procedure that includes inspecting the packet according to one or more rules to determine whether the packet is eligible for transmission to the user equipment, wherein the gateway refrains from paging the user equipment if the packet is not qualified.

2. The gateway of claim 1, further comprising a processor running software to qualify the packet and perform the inspection on the packet.

3. The gateway of claim 1, wherein the gateway includes a serving gateway (SGW) function.

4. The gateway of claim 1, wherein the interface configured to initiate a page request provides communication with a mobility management entity (MME).

5. The gateway of claim 1, further comprising an interface with a policy and charging rules function (PCRF) configured to receive a selective paging rule set to qualify packets received at the gateway.

6. The gateway of claim 5, wherein the selective paging rule set includes rules from a profile with user preferences for managing data received by the network.

7. The gateway of claim 1, further comprising a processor that performs the inspection on the packet and appends bearer information known at the gateway to the packet for review by a mobility management entity (MME).

8. A method of selective paging at a gateway in a communication network, the method comprising:
receiving a packet at the gateway;
determining to which user equipment the packet is destined;
accessing state information for that user equipment;
initiating, at the gateway, a qualifying procedure on the packet when the user equipment is in an idle state and the packet would trigger a page request;
inspecting the packet as part of the qualifying procedure according to rules to determine whether the packet is eligible to trigger a page request to the user equipment; and
sending a page request to the user equipment when the packet is determined to be eligible for transmission and refraining from sending the page request when the packet is determined to be ineligible for transmission.

9. The method of claim 8, wherein the gateway is a serving gateway (SGW).

10. The method of claim 9, further comprising receiving at the SGW a qualified packet from a packet data network gateway (PGW), wherein the PGW performed an inspection of the packet according to rules prior to sending the packet to the SGW.

11. The method of claim 8, further comprising receiving from a policy and charging rules function (PCRF) a selective paging rule set to qualify packets received at the gateway.

12. The method of claim 8, further comprising inspecting packet header fields based on at least one of shallow and deep packet inspection for each rule to determine eligibility for the packet.

13. The method of claim 8, further comprising receiving a profile from the user that includes preferences for what triggers a paging request.

14. The method of claim 8, further comprising:
appending bearer information known at the gateway to the packet of the packet; and
sending the packet with the appended bearer information for review by a mobility management entity (MME).

15. A gateway in a communication network that receives packets destined for user equipment, the gateway is configured qualify the packet to determine whether a page request should be sent to the user equipment by determining which user equipment the packet is destined for and whether the user equipment is in an idle state, and wherein the packet undergoes a qualification procedure based on an inspection according to one or more rules, wherein the gateway refrains from paging the user equipment if the packet is not qualified.

16. The gateway of claim 15, further comprising an interface with a policy and charging rules function (PCRF) configured to receive a selective paging rule set to qualify packets received at the gateway.

17. The gateway of claim 16, wherein the selective paging rule set includes rules from a profile with user preferences for managing data received by the network.

18. The gateway of claim 15, further comprising a processor that performs the inspection on the packet and appends bearer information known at the gateway to the packet for review by a mobility management entity (MME).

19. The gateway of claim 15, wherein the gateway includes a serving gateway (SGW) function.
